(19) United States
(12) Patent Application Publication
(10) Pub. No.: US 2014/0085902 A1
(43) Pub. Date: Mar. 27, 2014

(54) LUMINAIRE

(71) Applicant: TOSHIBA LIGHTING & TECHNOLOGY CORPORATION, Kanagawa (JP)

(72) Inventors: Kazunari HIGUCHI, Kanagawa (JP); Masashi Nakayama, Kanagawa (JP); Yusuke Ichijo, Kanagawa (JP); Hiroyuki Kuramochi, Shizuoka (JP)

(73) Assignee: Toshiba Lighting & Technology Corporation, Kanagawa (JP)

(21) Appl. No.: 13/730,069

(22) Filed: Dec. 28, 2012

(30) Foreign Application Priority Data
Sep. 24, 2012 (JP) 2012-210186

(51) Int. Cl. F21V 7/00

(52) U.S. Cl. CPC F21V 7/00
USPC 362/296.01

(57) ABSTRACT

According to one embodiment, a luminaire includes a main body made of metal, a light source, a reflector made of metal, a translucent cover made of glass, and an insulating member. The main body includes a light-source attaching section, an opening opposed to the light-source attaching section, a sidewall section, and a reflector supporting section. The reflector includes a flange section supported by the reflector supporting section in a non-contact manner and a reflection surface expanding from a daylight opening toward a floodlight opening. The translucent cover is provided on the floodlight opening side. The insulating member is configured to hold the flange section of the reflector and an outer edge portion of the translucent cover, and interposed between the flange section and the outer edge portion, and between the flange section and the reflector supporting section.

### CROSS-REFERENCE TO RELATED APPLICATION

This application is based upon and claims the benefit of priority from Japanese Patent Application No. 2012-210186, filed on Sep. 24, 2012; the entire contents of which are incorporated herein by reference.

### FIELD

Embodiments described herein relate generally to a luminaire.

### BACKGROUND

In a luminaire including an LED (Light Emitting Diode), power of the luminaire is increasing year after year. A heat value and a light beam amount of the luminaire increases. In particular, according to the increase in the light beam amount, there is a concern about deterioration due to light absorption of resin used in the luminaire.

Therefore, a reflector on which a largest amount of light is irradiated in the luminaire is desirably made of metal. If a distance between the reflector and a light source increases, the reflector does not sufficiently function because of an optical loss. Therefore, the reflector is arranged in the vicinity of the light source.

A main body (or a radiator) that holds the reflector is grounded. If the reflector is set in contact with the main body, the grounded reflector made of metal is close to the light source. As a result, a creepage distance between the light source, which is an energized portion, and the grounded reflector may not be able to be sufficiently secured.

### DESCRIPTION OF THE DRAWINGS

FIG. 1 is a perspective view of a luminaire according to an embodiment;

FIG. 2 is a perspective view of the luminaire;

FIG. 3 is a perspective view of a main body in the luminaire;

FIG. 4 is a perspective view of the main body in the luminaire;

FIG. 5 is a plan view of a light source in the luminaire;

FIG. 6 is an enlarged perspective view of a structure for attaching the light source to the main body in the luminaire;

FIG. 7 is a schematic sectional view of the luminaire;

FIG. 8 is a bottom view of the main body in the luminaire;

FIG. 9 is a perspective view of an insulating member shown in FIG. 7;

FIG. 10 is a perspective view of the main body in the luminaire;

FIG. 11 is a perspective view of the main body in the luminaire;

FIG. 12 is a perspective view of a holding member in the luminaire;

FIG. 13 is a perspective view of the holding member in the luminaire; and

FIG. 14 is a schematic sectional view of a luminaire according to another embodiment.

### DETAILED DESCRIPTION

In general, according to one embodiment, a luminaire includes: a main body made of metal, the main body including a light-source attaching section, an opening opposed to the light-source attaching section, a sidewall section provided between the light-source attaching section and an edge portion of the opening, and a reflector supporting section provided on the opening side in the sidewall section; a light source attached to the light-source attaching section of the main body; a reflector made of metal, the reflector including a flange section supported by the reflector supporting section of the main body in a non-contact manner and a reflection surface expanding from a daylight opening located on the light source side toward a floodlight opening located on the opening side of the main body; a translucent cover made of glass, the translucent cover being provided on the floodlight opening side of the reflector; and an insulating member configured to hold the flange section of the reflector and an outer edge portion of the translucent cover, and interposed between the flange section of the reflector and the outer edge portion of the translucent cover, and between the flange section of the reflector and the reflector supporting section of the main body.

Embodiments are explained below with reference to the accompanying drawings. In the drawings, the same components are denoted by the same reference numerals and signs.

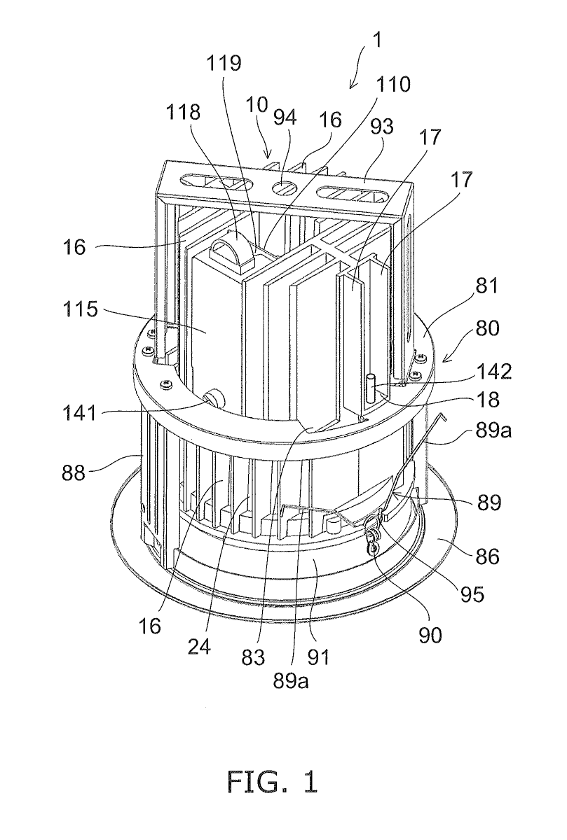

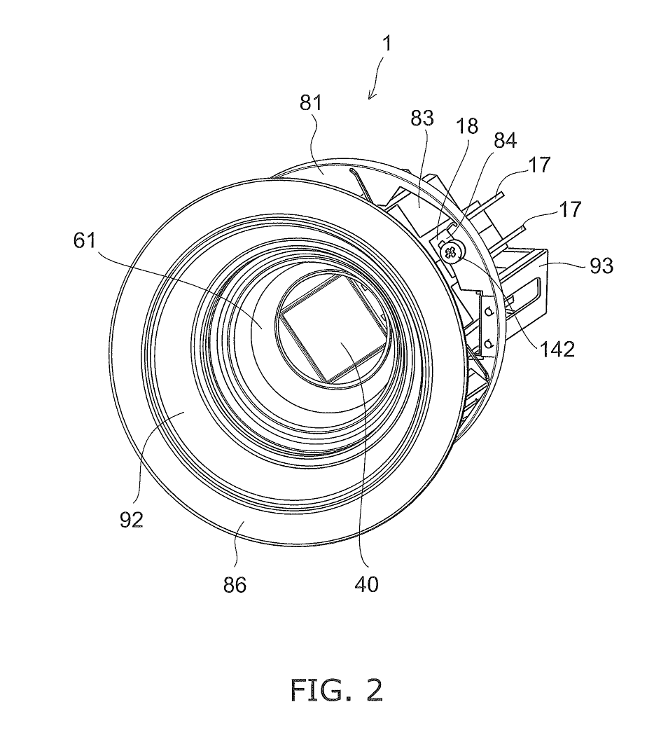

FIG. 1 is a perspective view of a luminaire 1 according to an embodiment. FIG. 2 is a perspective view of the luminaire 1 shown in FIG. 1 viewed from the bottom surface side.

The luminaire 1 according to this embodiment includes a main body 10, a light source 40 provided on the inside of the main body 10, and a holding member 80 configured to hold the main body 10.

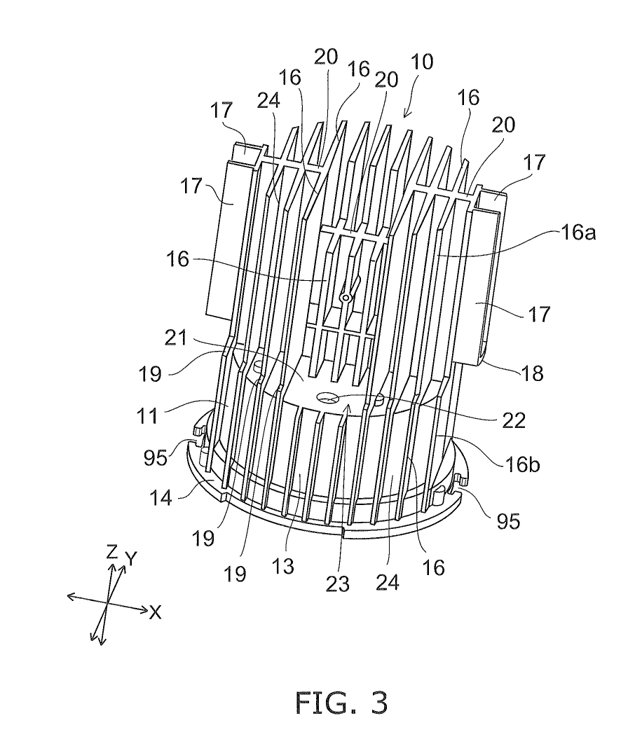

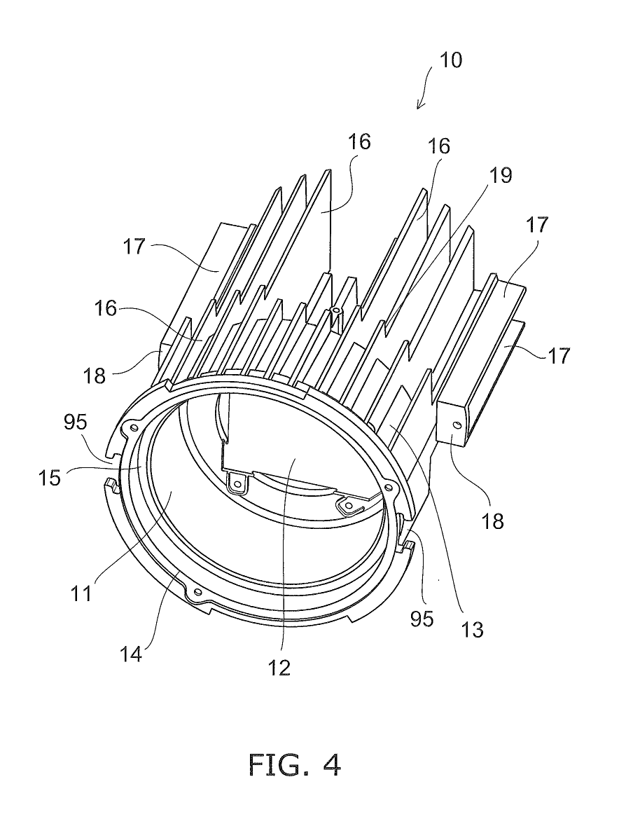

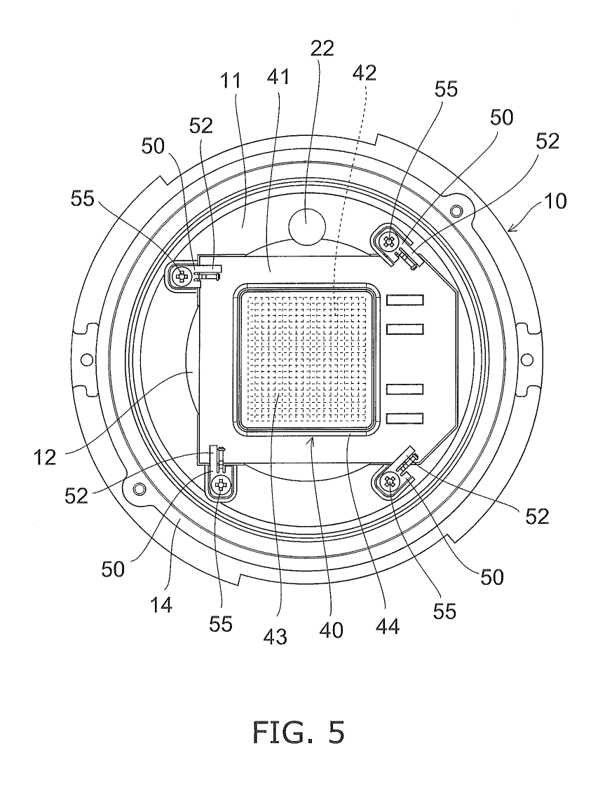

FIG. 3 is a perspective view of the main body 10. FIG. 4 is a perspective view of the main body 10 viewed from the bottom surface side. FIG. 5 is a bottom view of the main body 10.

The main body 10 is made of metal and used as a radiator as well. In this specification, “metal” is not limited to pure metal and includes an alloy as well. The main body 10 is, for example, a die-cast compact of aluminum.

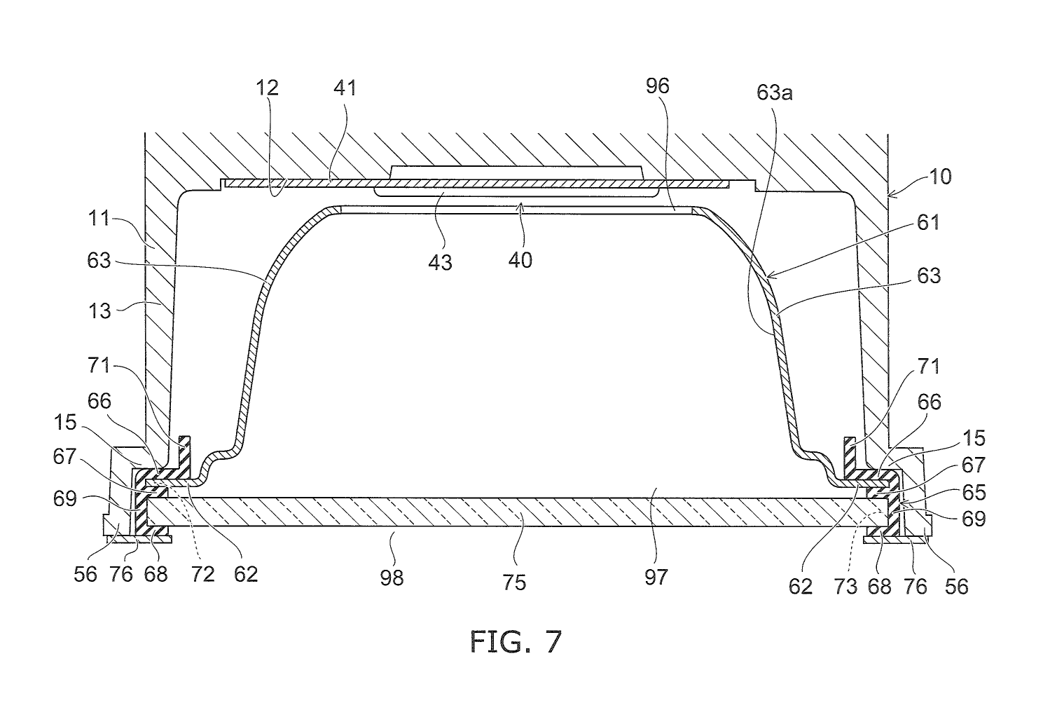

The main body 10 includes a light-source housing section 11 having a bowl-like container shape. The light-source housing section 11 includes, as shown in FIG. 4, a cylindrical sidewall section 13 and a light-source attaching section 12 provided at the upper end portion of the sidewall section 13. An opening 98 (shown in FIG. 7) opposed to the light-source attaching section 12 is formed on the lower end side of the sidewall section 13. A flange section 14 is provided at the peripheral edge portion of the opening 98. The sidewall section 13 is provided between the light-source attaching section 12 and the edge portion of the opening 98.

A ring-like reflector supporting section 15 is provided further on the light-source attaching section 12 side than the opening 98 on the inner side of the sidewall section 13. A step is formed between the flange section 14 and the reflector supporting section 15.

A plurality of first fins 16 are provided on the upper surface of the light-source housing section 11 (the rear surface side of the light-source attaching section 12), which is the rear surface of the light-source attaching section 12 and the outer wall of the sidewall section 13. The first fins 16 extend in the height direction of the main body 10 (in FIG. 3, a Z direction).

The plurality of first fins 16 are arrayed in an X direction orthogonal to the Z direction. Gaps 24 are formed among the first fins 16 adjacent to one another in the X direction.

Partition walls 20 extending in the X direction are provided on the upper surface of the light-source housing section 11. The first fins 16 extend in a Y direction orthogonal to the Z direction and the X direction while holding the partition walls 20 therebetween.

A step section 19 is provided halfway in the Z direction in each of the first fins 16. The first fin 16 includes a lower section 16b provided on the outer wall of the sidewall section 13 of the light-source housing section 11 and an upper section 16a provided on the upper surface of the light-source housing section 11. The step section 19 is provided between the upper section 16a and the lower section 16b of the first fin 16. The lower section 16b projects further to the outer side in the Y direction than the upper section 16a. In top view of the main body 10, a plurality of the step sections 19 are arrayed on a track that draws a circle.

Second fins 17 are provided on the outer walls of the first fins 16 provided on the outermost side in the X direction. Two second fins 17 are provided to be separated from each other in the Y direction at one end in the X direction in the partition wall 20. Two second fins 17 are provided to be separated from each other in the Y direction at the other end in the X direction in the partition wall 20.

The second fins 17 extend above the step section 19 and do not extend below the step section 19. Therefore, the length in the Z direction of the second fins 17 is smaller than the length in the Z direction of the first fins 16.

As shown in FIGS. 1 and 4, a screwing section 18 is provided between the lower end portions of the two second fins 17 adjacent to each other in the Y direction. The second fins 17 and the screwing section 18 project to the outer side in the X direction from the sidewall of the first fin 16 on the outermost side in the X direction.

As shown in FIG. 5, the light source 40 is attached to the light-source attaching section 12 of the main body 10 shown in FIG. 4.

The light source 40 includes a substrate 41 made of ceramics and a plurality of light-emitting elements 42 mounted on the substrate 41. The light-emitting elements 42 are, for example, LEDs (Light Emitting Diodes).

When, for example, a gallium nitride (GaN) compound semiconductor is used as a material of active layers of the LEDs, short-wavelength light having wavelength equal to or smaller than 500 nm is obtained. However, the material of the active layers is not limited to the gallium nitride compound semiconductor.

As the light-emitting elements 42, besides the LEDs, for example, organic light-emitting diodes (OLEDs), inorganic electroluminescence light-emitting elements, organic electroluminescence light-emitting elements, or other light-emitting elements of an electroluminescence type can be used.

The surfaces of the light-emitting elements 42 are covered with a phosphor layer 43. The phosphor layer 43 includes a resin layer and a plurality of particulate phosphors dispersed in the resin layer.

A mounting region of the light-emitting elements 42 is surrounded by resin 44 such as silicone. The phosphor layer 43 is supplied to the region surrounded by the resin 44. After being supplied in a liquid state, the phosphor layer 43 is thermally hardened. The spread of the liquid phosphor layer 43 is regulated by the resin 44.

In this embodiment, for example, with a combination of the light-emitting elements (LEDs) 42 that emit blue light and the phosphor layer 43 including phosphors that absorb the blue light (excitation light) and convert the blue light into yellow light, the light source 40 emits light of a white color, a bulb color, or the like as light of a mixed color of the blue light and the yellow light. As the phosphors, phosphors including red phosphors that emit red light and green phosphors that emit green light may be used.

The substrate 41 of the light source 40 is fixed by the light-source attaching section 12 of the main body 10 by metal spring members 50. As shown in FIG. 5, for example, the vicinities of the four corners of the substrate 41 are fixed to the light--source attaching section 12 by the metal spring members 50.

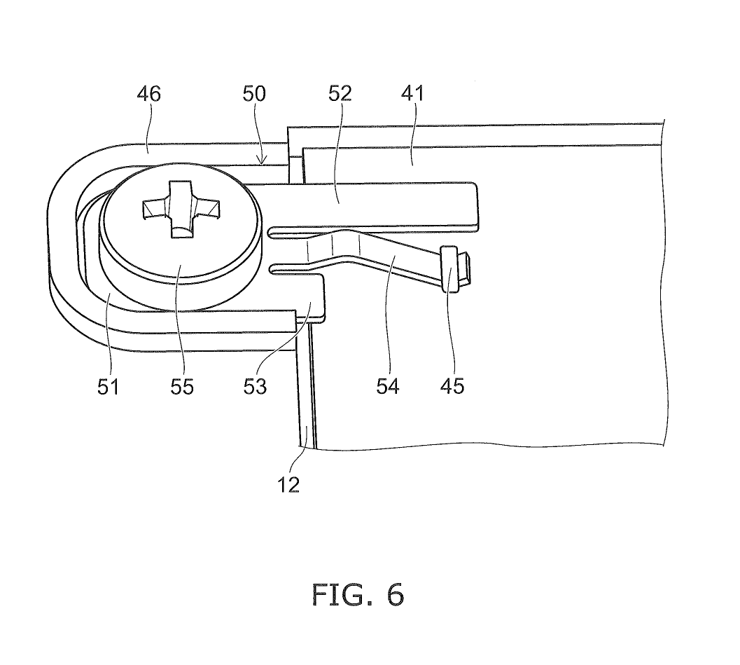

In FIG. 6, an enlarged perspective view of a portion of the substrate 41 attached to the light-source attaching section 12 by the metal spring member 50 is shown.

The metal spring member 50 is formed in a metal plate shape on which a screwing section 51, a pair of projecting sections 52 and 53 projecting from the screwing section 51, and a leaf spring section 54 projecting from the screwing section 51 between the pair of projecting sections 52 and 53 are integrally provided.

A rib 46, a plane shape of which is a U shape, is provided in the light-source attaching section 12. The screwing section 51 is fit on the inner side of the rib 46. The screwing section 51 is fixed to the light-source attaching section 12 by a screw 55. The rib 46 functions as a whirl stop for the screwing section 51.

Projection length of one projecting section 53 of the pair of projecting sections 52 and 53 is smaller than projection length of the other projecting section 52. As shown in FIG. 5, at least the projecting section 52 having large projection length of the pair of projecting sections 52 and 53 extends to a position where the projecting section 52 overlaps the substrate 41.

The leaf spring section 54 is a leaf spring cantilever-supported by the screwing section 51. The leaf spring section 54 presses the substrate 41 against the light-source attaching section 12 with urging force (elastic restoring force) thereof. The distal end portion of the leaf spring section 54 is hooked to a locking section 45 provided on the substrate 41. Positional fluctuation of a pressing portion of the leaf spring section 54 against the substrate 41 is regulated.

One projecting section 53 of the pair of projecting sections 52 and 53 is shorter than the other projecting section 52. Therefore, workability is high in gripping the leaf spring section 54 with fingers or a tool and inserting the distal end portion thereof into the locking section 45 to hook the distal end portion.

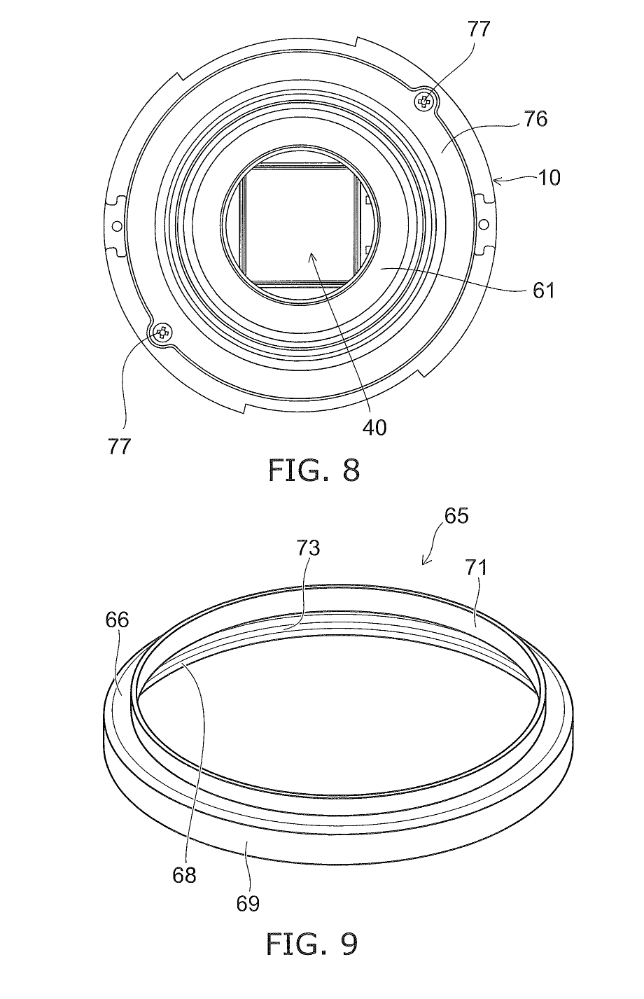

FIG. 7 is a schematic sectional view of the inside of the light-source housing section 11 of the main body 10. FIG. 8 is a bottom view of the light source 40 viewed from a translucent cover 75 side in FIG. 7.

A light emitting surface (a surface on which the light-emitting elements 42 are mounted or the front surface of the phosphor layer 43) of the light source 40 is faced to a space surrounded by the sidewall section 13 of the light-source housing section 11. A reflector 61 is provided in the space.

The reflector 61 is made of metal. The reflector 61 is made of, for example, aluminum subjected to alumite treatment (oxide film treatment) to be given a gloss after the surface thereof is buffed.

The reflector 61 includes a ring-like flange section 62 and a cylinder section 63 projecting from the circumferential edge portion on the inner side of the flange section 62 to the light source 40 side.

The distal end (the upper end in FIG. 7) of the cylinder section 63 projects to the vicinity of a light-emitting surface (a region where the light-emitting elements 42 and the phosphor layer 43 are provided) of the light source 40. The light-emitting surface of the light source 40 faces a space on the inner side of the cylinder section 63 of the reflector 61. The cylinder section 63 is separated from and not in contact with the light source 40.

A daylight opening 96 is formed on the light source 40 side in the cylinder section 63. A floodlight opening 97 is formed on the flange section 62 side in the cylinder section 63. The daylight opening 96 faces the light--emitting surface of the light source 40. The floodlight opening 97 faces the opening 98 at the lower end of the main body 10 via the translucent cover 75.

The daylight opening 96 and the floodlight opening 97 are formed in a circular shape or a shape close to the circular shape with the centers thereof aligned. The area of the daylight opening 96 is smaller than the area of the floodlight opening 97. The cylinder section 63 expands from the daylight opening 96 toward the floodlight opening 97. A reflection surface 63a is formed on the inner wall surface of the cylinder section 63.

The translucent cover 75 is provided below the reflector 61 and on the opening 98 side of the main body 10. The translucent cover 75 has transparency to light emitted from the light source 40. The translucent cover 75 is made of glass. The translucent cover 75 is formed in a circular plate shape and separated from the reflector 61 below the reflector 61 to cover an inner space of the light-source housing section 11.

The reflector 61 and the translucent cover 75 are held by an (one) insulating member 65 common to the reflector 61 and the translucent cover 75 and are attached to the main body 10.

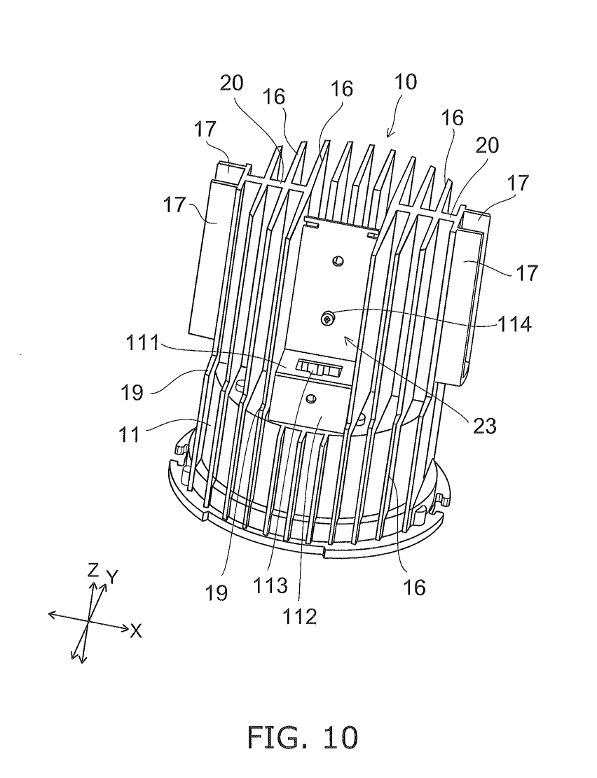

FIG. 9 is a perspective view of the insulating member 65.

The insulating member 65 is made of resin or rubber of a material that has electric insulation and is softer than the metal of the reflector 61 and the glass of the translucent cover 75. For example, the insulating member 65 is made of a material including silicone as a main component.

The insulating member 65 holds the flange section 62 of the reflector 61 and the outer edge portion of the translucent cover 75. The insulating member 65 is interposed between the flange section 62 of the reflector 61 and the outer edge portion of the translucent cover 75 and between the flange section 62 of the reflector 61 and the reflector supporting section 15 of the main body 10. The insulating member 65 includes a first ring section 66 interposed between the reflector supporting section 15 of the main body 10 and the flange section 62 of the reflector 61. The insulating member 65 includes a second ring section 67 interposed between the flange section 62 of the reflector 61 and the outer edge portion of the translucent cover 75. The insulating member 65 includes a third ring section 68 that covers the outer edge portion of the translucent cover 75 on the opposite side of the second ring section 67. Further, the insulating member 65 includes a side surface section 69 interposed between the side surface of the flange section 62 of the reflector 61 and the inner wall of the light-source housing section 11 and between the side surface of the translucent cover 75 and the inner wall of the light-source housing section 11.

An annular first groove 72 is formed between the first ring section 66 and the second ring section 67. The flange section 62 of the reflector 61 is inserted in the first groove 72.

An annular second groove 73 is formed between the second ring section 67 and the third ring section 68. The outer edge portion of the translucent cover 75 is inserted in the second groove 73.

The second groove 73 is formed under the first groove 72 across the second ring section 67. The outer edge portion of the translucent cover 75 is laid under the flange section 62 of the reflector 61 with the second ring section 67 interposed therebetween. The translucent cover 75 is separated from and not in contact with the flange section 62 of the reflector 61.

A ring-like pressing member 76 is laid on the third ring section 68 of the insulating member 65 and a lower end section 56 of the main body 10. The pressing member 76 is made of metal and screwed to the lower end section 56 of the main body 10 by screws 77 shown in FIG. 8.

As shown in FIG. 7, the insulating member 65 and the reflector 61 and the translucent cover 75 held by the insulating member 65 are sandwiched between the pressing member 76 and the reflector supporting section 15 of the main body 10 and held to the main body 10.

The insulating member 65 is interposed between the flange section 62 of the reflector 61 and the main body 10. The flange section 62 of the reflector 61 is not in contact with the main body 10. The cylinder section 63 of the reflector 61 is separated from and not in contact with the main body 10.

The main body 10 made of metal is grounded. The reflector 61 is not in contact with the main body 10 and the light source 40 and is electrically floating.

A light reflecting function is mainly assumed by the cylinder section 63 of the reflector 61. On the other hand, the flange section 62 of the reflector 61 is a portion supported with respect to the main body 10. Therefore, the flange section 62 is closer to the main body 10 than the cylinder section 63.

According to this embodiment, it is possible to, while realizing high reliability by forming the reflector 61 with the metal superior to resin in durability rather than with the resin likely to be deteriorated because of light absorption, secure a sufficient creepage distance (a shortest distance along an insulator surface between two conductive portions) between the flange section 62 of the reflector 61 and the main body 10 by interposing the insulating member 65 between the flange section 62 of the reflector 61 and the main body 10.

It is possible to prevent a deficiency due to the resin deterioration by using glass rather than the resin for the translucent cover 75. The translucent cover 75 of glass is likely to be broken when being directly set in contact with the reflector 61 of metal. However, according to this embodiment, the translucent cover 75 of glass is protected by interposing the insulating member 65 between the flange section 62 of the reflector 61 and the translucent cover 75.

The one insulating member 65 is used for both of the protection of the translucent cover 75 of glass and the insulation of the reflector 61 and the main body 10. Therefore, it is possible to suppress an increase in the number of components. As a result, it is possible to realize a reduction in costs. Further, it is possible to improve assemblability for assembling the insulating member 65, the reflector 61, and the translucent cover 75 to the main body 10.

According to this embodiment, as shown in FIG. 7, the insulating member 65 further includes an extending section 71 projecting from the first ring section 66 to the light source 40 side. The extending section 71 is interposed between the sidewall section 13 of the main body 10 and the cylinder section 63 of the reflector 61 and formed in a ring shape or a cylindrical shape that surrounds the circumference of the cylinder section 63 of the reflector 61.

In the cylinder section 63 of the reflector 61, a lower part close to the flange section 62 has a distance to the sidewall section 13 of the main body 10 shorter than a distance from an upper part on the light source 40 side to the sidewall section 13. Since the extending section 71 of the insulating member 65 is interposed between the lower part of the cylinder section 63 and the main body 10, it is possible to sufficiently secure a creepage distance between the lower part of the cylinder section 63 and the main body 10.

The extending section 71 of the insulating member 65 is separated from and not in close contact with the cylinder section 63 of the reflector 61. Therefore, the insulating member 65 can be universally used for the reflector 61 including the cylinder section 63 having various sizes and shapes.

The extending section 71 of the insulating member 65 is separated from and not in contact with the inner wall of the main body 10. Therefore, when the ring-like insulating member 65 is inserted into the main body 10, deterioration in insertion workability due to collision of the extending section 71 against the inner wall of the main body 10 is not caused.

As shown in FIG. 3, a connector attachment space 23 is provided on the upper surface of the light-source housing section 11 of the main body 10. The connector attachment space 23 is formed by setting projection length of apart of the first fins 16 in the Y direction smaller than projection length of the other first fins 16.

The first fins 16 are located to partition the connector attachment space 23 at both ends in the X direction of the connector attachment space 23. The first fins 16 are located to hold the connector attachment space 23 therebetween in the X direction. A through-hole 22 is formed on a bottom surface (the upper surface of the light-source housing section 11) 21 of the connector attachment space 23.

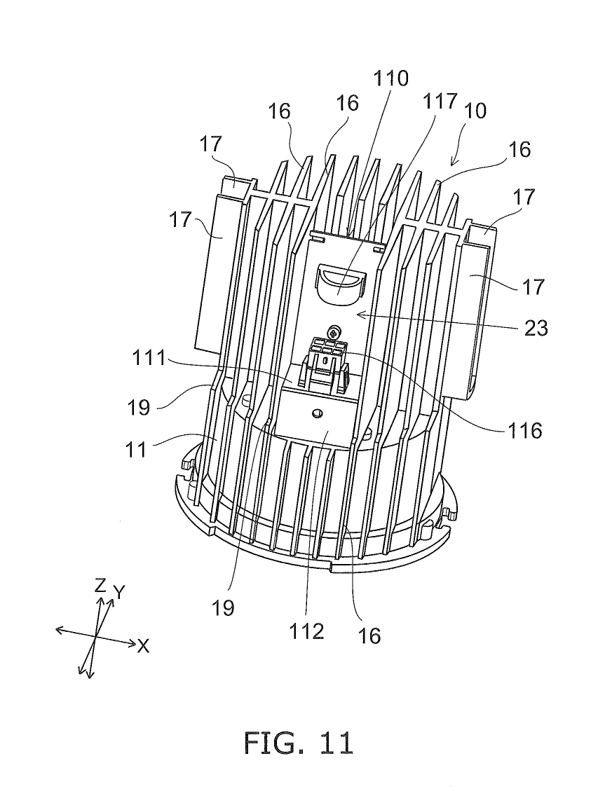

In the connector attachment space 23, as shown in FIGS. 10 and 11, a connector fixing fitting 110 is provided. The connector fixing fitting 110 is screwed to the first fin 16 by a screw 114.

A space on the bottom surface side in the connector attachment space 23 is surrounded by a side plate section 112 of the connector fixing fitting 110 and a connector supporting plate 111. An opening 113 is formed in the connector supporting plate 111.

On the connector supporting plate 111, as shown in FIG. 11, a connector (or a terminal block) 116 is provided. The connector 116 is electrically connected to the light source 40, which is provided in the light-source attaching section 12 on the rear side of the upper surface of the light-source housing section 11, by a wiring cable inserted through the opening 113 formed in the connector supporting plate 111 and the through-hole 22 formed on the upper surface of the light-source housing section 11.

A wire insertion port of the connector 116 is faced upward in the height direction of the main body 10 (the Z direction). A cable guide 117 is attached to the connector fixing fitting 110.

A wiring cable connected to a lighting unit provided separately from the luminaire 1 is inserted from above to below the cable guide 117 and is directly inserted into the wire insertion port of the connector 116 below the cable guide 117. The lighting unit and the light source 40 are electrically connected via the connector 116. An output of the lighting unit is sent to the light source 40.

After the wiring cable of the lighting unit is connected to the connector 116, the connector attachment space 23 is covered by a connector cover 115 shown in FIG. 1. The connector cover 115 is screwed to the side plate section 112 of the connector fixing fitting 110 by a screw 141. A connected section of the connector 116 and the wiring cable is protected from dust and the like by the connector cover 115.

The wiring cable connected to the connector 116 in the connector attachment space 23 on the inner side of the connector cover 115 is led out to the outside of the connector attachment space 23 through a cutout 119 formed between the connector cover 115 and the connector fixing fitting 110. Further, the wiring cable is connected to the lighting unit through a cable guide 118 provided on the upper surface of the connector cover 115.

As shown in FIG. 11, the wire insertion port of the connector 116 is faced upward. The wiring cable is extended in the height direction of the main body 10 and drawn out to above the main body 10 while being guided by the cable guide 117. The connector fixing fitting 110 and the connector 116 attached to the connector fixing fitting 110 are provided in the space 23 between the first fins 16 and do not project further in the Y direction than the first fins 16.

Therefore, when the main body 10 is inserted through the inner side of a main body attachment ring 81 explained later, the connector 116 and the wiring cable do not obstruct the insertion. As a result, assemblability is excellent.

The holding member 80 is explained.

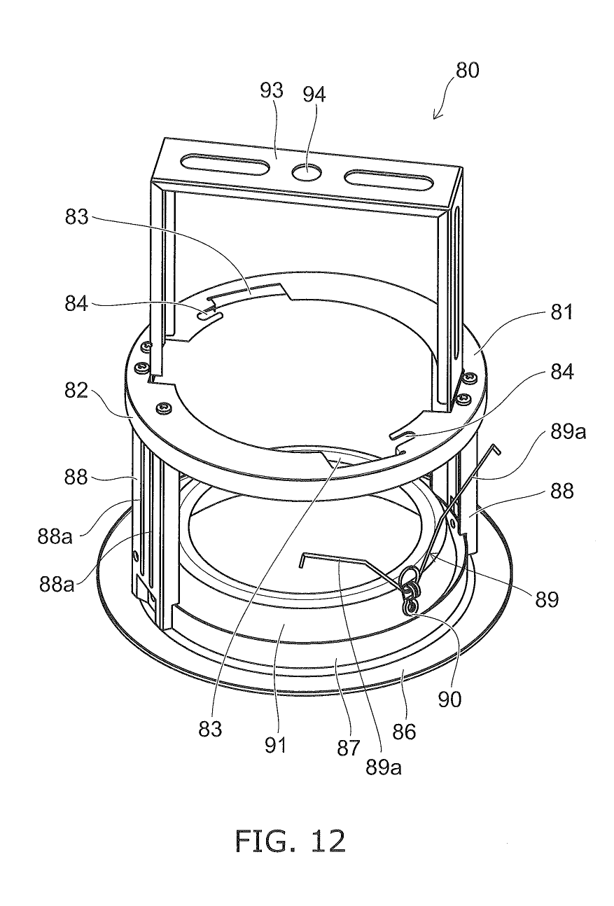

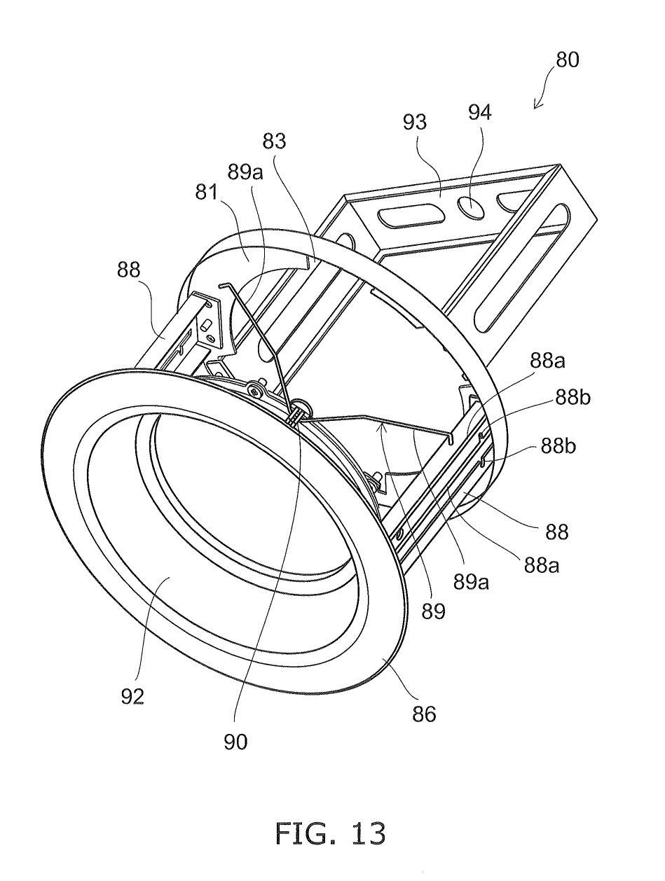

FIGS. 12 and 13 are perspective views of the holding member 80.

The holding member 80 includes a main body attachment ring (hereinafter simply referred to as attachment ring as well) 81 to which the main body 10 is attached.

At the edge portion on the outer circumference side of the attachment ring 81, a rib 82 projecting downward is continuously provided along the circumferential direction of the attachment ring 81. The rib 82 increases the strength of the attachment ring 81.

In the attachment ring 81, a pair of cutouts 83 opened on the inner circumference side are formed. The pair of cutouts 83 are formed in positions across the center of the attachment ring 81 in the diameter direction. In the cutouts 83, U-shape grooves 84 continuously connected to the cutouts 83 are formed in the circumferential direction at one end portions in the circumferential direction of the attachment ring 81.

An angle member 93 is provided above the attachment ring 81. The lower end portions of the angle member 93 are screwed to the attachment ring 81.

A ring-like decoration frame 86 is provided below the attachment ring 81. The decoration frame 86 includes a cylinder section 87 projecting from the edge portion on the inner circumference side to the attachment ring 81 side.

The attachment ring 81 and the decoration frame 86 are coupled by two chassis 88. The two chassis 88 are provided in positions across the center of the attachment ring 81 in the diameter direction and in positions across the center of the decoration frame 86 in the diameter direction. The attachment ring 81 and the decoration frame 86 overlap each other while being separated vertically with the centers thereof aligned.

The upper end portions of the chassis 88 are screwed to the lower surface of the attachment ring 81. The lower end portions of the chassis 88 are screwed to the cylinder section 87 of the decoration frame 86.

A cylindrical reflecting mirror 92 is fit in the inner side of the decoration frame 86. Apart of the upper end portion side of the reflecting mirror 92 projects above the cylinder section 87 of the decoration frame 86 (to the attachment ring 81 side). A cylindrical attachment fitting 91 is attached to the outer circumferential surface of the projecting section of the reflecting mirror 92. The reflecting mirror 92 and the attachment fitting 91 are detachably attachable without being fixed to the decoration frame 86 and the chassis 88.

A pair of couplings 90 are screwed to the outer wall of the attachment fitting 91. V-shape springs 89 are coupled to the respective couplings 90. A pair of V-shape springs 89 are provided in positions across the center of the decoration frame 86 in the diameter direction.

A method of attaching the main body 10 to the holding member 80 is explained.

The main body 10 is moved relatively to the holding member 80 in the axis direction of the attachment ring 81 and inserted through the inner side of the attachment ring 81. The main body 10 is inserted into the inner side of the decoration frame 86 and the inner side of the reflecting mirror 92 from the upper end portion side of the fins 16 and 17.

In a state in which the second fins 17 are positioned in the cutouts 83 of the attachment ring 81, the main body 10 is inserted through the inner side of the attachment ring 81 and the second fins 71 are moved to above the attachment ring 81.

The step sections 19 formed halfway in the height direction of the first fins 16 come into contact with the lower surface of the attachment ring 81, whereby the main body 10 inserted through the inner side of the attachment ring 81 from the lower surface side of the attachment ring 81 is regulated from moving upward with respect to the attachment ring 81. Therefore, it is possible to surely position the main body 10 with respect to the holding member 80.

Since the step sections 19 formed in the first fins 16 are used, another component does not have to be used to position the main body 10 with respect to the holding member 80. Therefore, it is possible to realize a reduction of components and a reduction in costs by simplification of the structure.

When the second fins 17 are moved to above the attachment ring 81, the main body 10 and the attachment ring 81 are relatively rotated in the circumferential direction of the attachment ring 81. The screwing section 18 at the lower end portion of the second fins 17 is moved to a supporting position on the attachment ring 81 deviating from the cutout 83.

Specifically, the screwing section 18 of the second fins 17 is moved from the cutout 83 in the attachment ring 81 to a position where the U-shape groove 84 is formed. The second fins 17 are supported on the peripheral portion of the U-shape groove 84 in the attachment ring 81 and extends to above the attachment ring 81.

The screwing section 18 of the second fins 17 is screwed and fixed to the attachment ring 81. A screw 142 shown in FIGS. 1 and 2 pierces through the U-shape groove 84 of the attachment ring 81 from the lower surface side of the attachment ring 81 and is coupled to a screw hole formed in the screwing section 18 of the second fins 17. As shown in FIG. 1, an axis portion of the screw 142 projects to a space between the second fins 17. A washer is interposed between the head of the screw 142 and the lower surface of the attachment ring 81.

The pressing member 76 shown in FIGS. 7 and 8 screwed to the lower end portion of the main body 10 is opposed to the upper end of the reflecting mirror 92 of the holding member 80 and the upper end of the attachment fitting 91 via a very small gap. The translucent cover 75 faces a space on the inner side of the reflecting mirror 92 above the upper end of the reflecting mirror 92.

Light emitted from the light source 40 is subjected to light distribution control by the reflector 61, the translucent cover 75, and the reflecting mirror 92 and emitted to the outside below the decoration frame 86.

According to this embodiment, the second fins 17 that assume a heat radiating function is caused to also assume a function of fixing the main body 10 to the attachment ring 81. Therefore, it is possible to perform efficient design without waste and realize a reduction in size, a reduction in weight, and a reduction in costs through a reduction in the number of components.

The first fins 16 longer in the height direction (the Z direction) than the second fins 17 extend to above and below the attachment ring 81. The gaps 24 continuing from blow to above the attachment ring 81 are formed among the plurality of first fins 16. Therefore, convection of the air along the Z direction of the first fins 16 is not obstructed by the attachment ring 81. The main body 10 can sufficiently show the function of the radiator.

The holding member 80 that holds the main body 10 can be attached to a luminaire attaching targets such as the ceiling via, for example, the angle member 93. A bolt suspended from the ceiling is inserted through the through-hole 94 of the angle member 93. A nut is coupled to the bolt projecting to the lower surface side of the angle member 93.

As shown in FIG. 13, two slits 88a are formed in the chassis 88. The two slits 88a extend in a direction for connecting the attachment ring 81 and the decoration frame 86. U-shape grooves 88b projecting in the width direction of the slit 88a are formed on the attachment ring 81 side in the slits 88a. The U-shape groove 88b formed in one slit 88a of the two slits 88a projects in a direction away from the other slit 88a.

A not-shown attachment fitting is inserted into the slits 88a to be capable of moving up and down. The attachment fitting is hooked to the U-shape grooves 88b, whereby the attachment fitting is regulated from moving up. The attachment fitting regulated from moving up presses the ceiling, whereby the luminaire 1 is held to the ceiling.

A pair of arms 89a of the V-shape spring 89 are squeezed in a direction in which the arms 89a approach each other. The arms 89a are engaged with a cutout 95 formed in the flange section 14 at the lower end of the main body 10 shown in FIG. 3.

In FIG. 1, a state in which the arms 89a of the V-shape spring 89 are engaged with the cutout 95 of the main body 10 is shown. After the arms 89a are engaged with the cutout 95, when force for squeezing the arms 89a is released, the pair of arms 89a expand with an elastic restoring force.

According to the expanding action of the pair of arms 89a, the V-shape spring 89 moves up with respect to the main body 10. The vicinity of the bases of the arms 89a engages with the cutout 95. In other words, the expanding force of the arms 89a changes to a force for pushing up the V--shape spring 89 with respect to the main body 10. The reflecting mirror 92 coupled to the V-shape spring 89 fits in the inner side of the decoration frame 86. The attachment fitting 91 and the reflecting mirror 92 attached to the attachment metal 91 are supported with respect to the main body 10 via the V-shape spring 89.

The attachment ring 81 is located substantially in the middle in the height direction of the main body 10. The V-shape spring 89 is exposed to below the attachment ring 81. Therefore, the attachment ring 81 does not obstruct the operation of the V-shape spring 89.

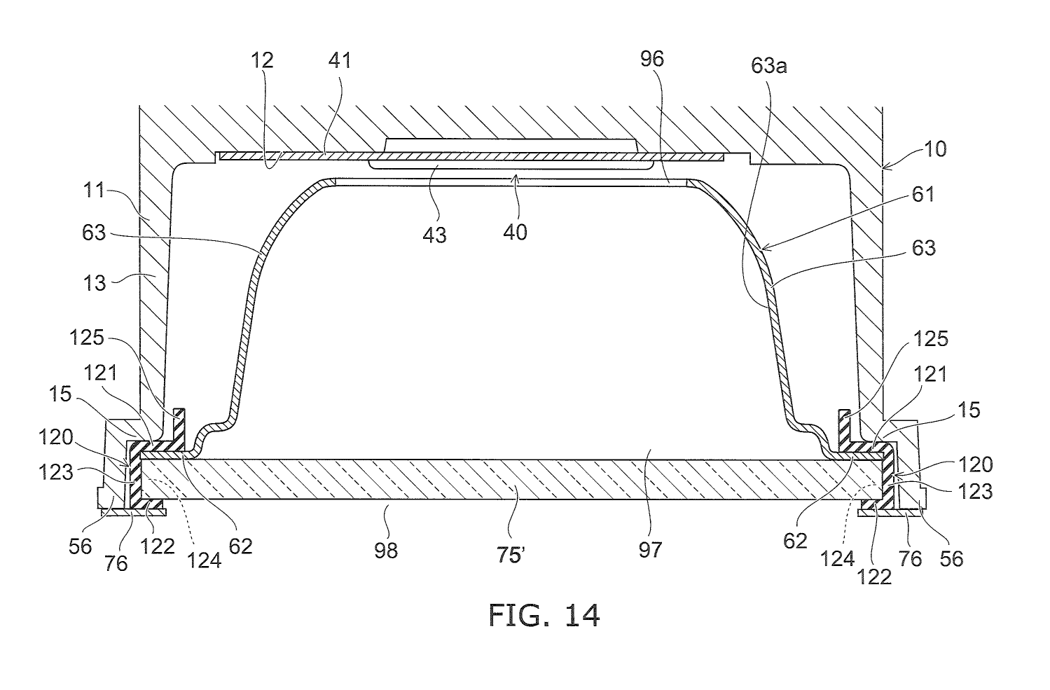

FIG. 14 is a schematic sectional view of another specific example of a holding structure for the reflector 61 and a translucent cover 75′.

As in the embodiment, the reflector 61 is made of metal. The reflector 61 includes the ring-like flange section 62 and the cylinder section 63 projecting from the circumferential edge portion on the inner side of the flange section 62 to the light source 40 side.

The translucent cover 75′ is provided to be laid on the lower surface of the flange section 62 of the reflector 61. The translucent cover 75′ has transparency to light emitted from the light source 40. The translucent cover 75′ is made of resin such as acrylic or polycarbonate. The translucent cover 75′ is formed in a circular plate shape to cover the inner space of the light-source housing section 11.

The reflector 61 and the translucent cover 75′ are held by a common (one) insulating member 120 and attached to the main body 10.

The insulating member 120 is made of resin or rubber having electric insulation. For example, the insulating member 120 is made of a material including silicone as a main component.

The insulating member 120 holds the flange section 62 of the reflector 61 and the outer edge portion of the translucent cover 75′. The insulating member 120 is interposed between the flange section 62 of the reflector 61 and the reflector supporting section 15 of the main body 10.

The insulating member 120 includes a first ring section 121 interposed between the reflector supporting section 15 of the main body 10 and the flange section 62 of the reflector 61. The insulating member 120 includes a second ring section 122 laid on the surface of the outer edge portion of the translucent cover 75′. Further, the insulating member 120 includes a side surface section 123 interposed between the side surface of the flange section 62 of the reflector 61 and the inner wall of the light-source housing section 11 and between the side surface of the translucent cover 75′ and the inner wall of the light-source housing section 11.

An annular groove 124 is formed between the first ring section 121 and the second ring section 122. The flange section 62 of the reflector 61 and the outer edge portion of the translucent cover 75′ are inserted in the groove 124. The outer edge portion of the translucent cover 75′ is in contact with and overlaps the flange section 62 of the reflector 61. Since the translucent cover 75′ is made of resin, even if the translucent cover 75′ is in contact with the reflector 61 of metal, it is unlikely that the translucent cover 75′ is damaged, for example, chipped.

The ring-like pressing member 76 is laid on the second ring section 122 of the insulating member 120 and the lower end section 56 of the main body 10. The pressing member 76 is made of metal and screwed to the lower end section 56 of the main body 10 by the screws 77 shown in FIG. 8.

As shown in FIG. 14, the insulating member 120 and the reflector 61 and the translucent cover 75′ held by the insulating member 120 are sandwiched between the pressing member 76 and the reflector supporting section 15 of the main body 10 and held to the main body 10.

In the structure shown in FIG. 14, as in the embodiment, the insulating member 65 is interposed between the flange section 62 of the reflector 61 and the main body 10. The flange section 62 of the reflector 61 is not in contact with the main body 10. The cylinder section 63 of the reflector 61 is separated from and not in contact with the main body 10. The reflector 61 is not in contact with the main body 10 and the light source 40 and is electrically floating.

Therefore, it is possible to, while realizing high reliability by forming the reflector 61 with the metal superior to resin in durability rather, secure a sufficient creepage distance between the flange section 62 of the reflector 61 and the main body 10 by interposing the insulating member 120 between the flange section 62 of the reflector 61 and the main body 10.

The one insulating member 120 is used for both of the holding of the reflector 61 and the holding of the translucent cover 75′. Therefore, it is possible to suppress an increase in the number of components. As a result, it is possible to realize a reduction in costs. Further, it is possible to improve assemblability for assembling the insulating member 120, the reflector 61, and the translucent cover 75′ to the main body 10.

The insulating member 120 further includes an extending section 125 projecting from the first ring section 121 to the light source 40 side. The extending section 125 is interposed between the sidewall section 13 of the main body 10 and the cylinder section 63 of the reflector 61 and formed in a ring shape or a cylindrical shape that surrounds the circumference of the cylinder section 63 of the reflector 61.

In the cylinder section 63 of the reflector 61, a lower part close to the flange section 62 has a distance to the sidewall section 13 of the main body 10 shorter than a distance from an upper part on the light source 40 side to the sidewall section 13. Since the extending section 125 of the insulating member 120 is interposed between the lower part of the cylinder section 63 and the main body 10, it is possible to sufficiently secure a creepage distance between the lower part of the cylinder section 63 and the main body 10.

The extending section 125 of the insulating member 120 is separated from and not in close contact with the cylinder section 63 of the reflector 61. Therefore, the insulating member 120 can be universally used for the reflector 61 including the cylinder section 63 having various sizes and shapes.

The extending section 125 of the insulating member 120 is separated from and not in contact with the inner wall of the main body 10. Therefore, when the ring-like insulating member 120 is inserted into the main body 10, deterioration in insertion workability due to collision of the extending section 125 against the inner wall of the main body 10 is not caused.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A luminaire comprising:
a main body made of metal, the main body including a light-source attaching section, an opening opposed to the light-source attaching section, a sidewall section provided between the light-source attaching section and an edge portion of the opening, and a reflector supporting section provided on the opening side in the sidewall section;
a light source attached to the light-source attaching section of the main body;
a reflector made of metal, the reflector including a flange section supported by the reflector supporting section of the main body in a non-contact manner and a reflection surface expanding from a daylight opening located on the light source side toward a floodlight opening located on the opening side of the main body;
a translucent cover made of glass, the translucent cover being provided on the floodlight opening side of the reflector; and
an insulating member configured to hold the flange section of the reflector and an outer edge portion of the translucent cover, and interposed between the flange section of the reflector and the outer edge portion of the translucent cover, and between the flange section of the reflector and the reflector supporting section of the main body.

2. The luminaire according to claim 1, wherein the insulating member includes:
a first ring section interposed between the reflector supporting section of the main body and the flange section of the reflector;
a second ring section interposed between the flange section of the reflector and the outer edge portion of the translucent cover;
a third ring section configured to cover the outer edge portion of the translucent cover on an opposite side of the second ring section;
a first groove formed between the first ring section and the second ring section, the flange section of the reflector being inserted in the first groove;
a second groove formed between the second ring section and the third ring section, the outer edge portion of the translucent cover being inserted in the second groove; and
a side surface section interposed between a side surface of the flange section of the reflector and the main body, and between a side surface of the translucent cover and the main body.

3. The luminaire according to claim 2, further comprising a pressing member laid on the third ring section of the insulating member and a lower end portion of the main body, and fixed to the lower end portion of the main body, wherein
the insulating member, the flange section of the reflector, and the outer edge portion of the translucent cover are sandwiched between the pressing member and the reflector supporting section of the main body, and held to the main body.

4. The luminaire according to claim 3, wherein the pressing member is made of metal and screwed to the lower end portion of the main body.

5. The luminaire according to claim 2, wherein the insulating member further includes an extending section projecting from the first ring section to the light-source attaching section side, interposed between the main body and the reflector, and configured to surround a circumference of the reflector.

6. The luminaire according to claim 1, wherein the translucent cover overlaps the reflector in a non-contact manner.

7. The luminaire according to claim 1, wherein the insulating member is made of resin or rubber.

8. The luminaire according to claim 7, wherein the insulating member includes silicone as a main component.

9. The luminaire according to claim 1, wherein the main body is grounded and the reflector is electrically floating.

10. A luminaire comprising:
a main body made of metal, the main body including a light-source attaching section, an opening opposed to the light-source attaching section, a sidewall section provided between the light-source attaching section and an edge portion of the opening, and a reflector supporting section provided on the opening side in the sidewall section;
a light source attached to the light-source attaching section of the main body;
a reflector made of metal, the reflector including a flange section supported by the reflector supporting section of the main body in a non-contact manner and a reflection surface expanding from a daylight opening located on the light source side toward a floodlight opening located on the opening side of the main body;
a translucent cover made of resin, the translucent cover being laid on the flange section of the reflector; and
an insulating member interposed between the flange section of the reflector and the reflector supporting section of the main body.

11. The luminaire according to claim 10, wherein the insulating member includes:
a first ring section interposed between the reflector supporting section of the main body and the flange section of the reflector;
a second ring section laid on an outer edge portion of the translucent cover; and
a side surface section interposed between a side surface of the flange section of the reflector and the main body, and between a side surface of the translucent cover and the main body.

12. The luminaire according to claim 11, further comprising a pressing member laid on the second ring section of the insulating member and a lower end portion of the main body, and fixed to the lower end portion of the main body, wherein
the insulating member, the flange section of the reflector, and the outer edge portion of the translucent cover are sandwiched between the pressing member and the reflector supporting section of the main body, and held to the main body.

13. The luminaire according to claim 12, wherein the pressing member is made of metal and screwed to the lower end portion of the main body.

14. The luminaire according to claim 11, wherein the insulating member further includes an extending section projecting from the first ring section to the light source side, interposed between the main body and the reflector, and configured to surround a circumference of the reflector.

15. The luminaire according to claim 10, wherein the insulating member is made of resin or rubber.

16. The luminaire according to claim 15, wherein the insulating member includes silicone as a main component.

17. The luminaire according to claim 10, wherein the main body is grounded and the reflector is electrically floating.

18. A luminaire comprising:
a light source;
a main body made of metal having sidewalls that form an opening through which light from the light source is to be emitted;
a reflector made of metal housed in the opening without contacting the main body and having sidewalls that form an upper opening through which the light from the light source is to be emitted and a lower opening larger than the upper opening through which the light from the light source that passes through the upper opening is to be emitted;
a translucent cover positioned to cover the lower opening and through which the light from the light source that passes through the upper and lower openings is to be emitted; and
an insulating member interposed between the reflector and the main body to support the reflector against the main body in a non-contact manner.

19. The luminaire according to claim 18, wherein the insulating member is also interposed between the reflector and the translucent cover and between the translucent cover and the main body.

20. The luminaire according to claim 19, wherein the insulating member includes:
a first ring section interposed between the reflector and the main body;
a second ring section interposed between the reflector and the translucent cover; and
a third ring section configured to cover an outer edge portion of the translucent cover on a side of the translucent cover that faces away from a direction of the light to be emitted from the light source that passes through the translucent cover.
